(19) United States
(12) Patent Application Publication
(10) Pub. No.: US 2014/0355780 A1
(43) Pub. Date: Dec. 4, 2014

(54) HEADPHONES AND HEADPHONE DRIVER

(71) Applicant: D&M Holdings, Inc., Kawasaki-shi, Kanagawa (JP)

(72) Inventor: Yoshinari Fukushima, Kanagawa (JP)

(21) Appl. No.: 14/368,815

(22) PCT Filed: Dec. 21, 2012
(86) PCT No.: PCT/JP2012/083214

§ 371 Date: Jun. 26, 2014

(30) Foreign Application Priority Data
Dec. 26, 2011 (JP) 2011-283069
Dec. 26, 2011 (JP) 2011-283070

(51) Int. Cl. H04R 1/10

(52) U.S. Cl. CPC H04R 1/1058; H04R 2201/105; H04R 2209/024
USPC 381/74

(57) ABSTRACT

[Problem] To provide headphones that can be inexpensively manufactured without requiring any high-level manufacturing technology in terms of manufacturing of a diaphragm, and is capable of reproducing an audio signal without sound deterioration in a wide range of frequency band by minimizing resonant frequencies at high frequencies. [Solution] For headphones that are equipped with two headphone driver units, ear pads that are provided on the head-phone driver units, and a headphone band for connecting the two headphone driver units together, each headphone driver unit is equipped with a headphone driver comprising a diaphragm, a voice coil which is fixed to the diaphragm, a magnet which is positioned next to the voice coil, a yoke which is provided opposite to the magnet via a voice coil, and a frame for mounting the magnet and the yoke and for fixing a periphery section of the diaphragm, wherein the diaphragm is molded by using a mixture of a paper material and a nanofiber material.

### TECHNICAL FIELD

The present invention relates to a headphone device and a headphone driver.

### BACKGROUND ART

In a headphone device, a headphone driver for outputting an audio signal includes a diaphragm, a magnetic circuit including a voice coil, a yoke, and a magnet, and a frame. In general, the diaphragm for headphone driver use is formed of a polyester material because the polyester material facilitates production of the diaphragm and compact molding of the diaphragm for headphone driver use. Examples of the material of the diaphragm include polyetherimide and metal in addition to polyester. A paper material or the like is used for the material of a large-sized diaphragm for speaker use.

A diaphragm made of a material such as polyester has an advantage in that the diaphragm can be downsized and easily manufactured, but has the following disadvantage. Internal loss is smaller than that of a diaphragm made of a paper material, and sound pressure frequency characteristics have peaks and dips. Thus, high sound quality cannot be obtained.

FIG. 5 are images each showing a vibration region of a diaphragm made of a polyester material used in a related-art headphone driver.

In FIG. 5, a dark shaded area in a circle represents a vibration center position. When the frequency is low, as shown in FIG. 5(a), the diaphragm made of the polyester material vibrates without any distortion in a manner that the whole diaphragm surface moves in the same way. When the frequency becomes higher, as shown in FIG. 5(b), two different vibration surfaces are generated on the diaphragm surface. When the frequency becomes still higher, as shown in FIG. 5(c), a plurality of vibration portions are further generated on the diaphragm surface. The generation of different vibration surfaces on the diaphragm surface at high frequency is responsible for the occurrence of distortion in frequency characteristics of the diaphragm, such as peaks and dips. This adversely affects sound quality of an audio signal to be reproduced.

Another method is employed, involving vapor-depositing a material such as polyester on a polymer film, but this method does not remarkably improve the characteristics, whereas making the manufacturing process complicated due to an additional vapor deposition step, and also leading to an increase in cost of the diaphragm. Polyester is thus not suitable for the material of the diaphragm.

On the other hand, a diaphragm using paper as its material is widely used because of easy handling of the material and because of good sound quality with less peaks and dips caused by the resonance frequency owing to high internal loss. However, in a headphone driver using a paper-made diaphragm, when the diaphragm is fixed directly to a frame, the compliance of the diaphragm may be decreased to increase the minimum resonance frequency, and hence reproducibility at low frequency may be decreased.

FIG. 6 is a graph showing frequency characteristics of the related-art headphone driver.

In the frequency characteristics shown in FIG. 6, the minimum resonance frequency is around 60 Hz, and hence the signal level gradually decreases from around 60 Hz. It follows that the signal level becomes lower as the frequency becomes lower, which leads to a decrease in sound quality of an audio signal in a low-pitched range.

As a method of solving such a problem that the minimum resonance frequency is high over the entire diaphragm, there is known a method in which an edge portion using a material different from that of the diaphragm is provided between the diaphragm and the frame.

As the technology described above, which is aimed at improving the performance of the diaphragm and improving the frequency characteristics of the diaphragm in the low-pitched range, Patent Literature 1 discloses a technology of forming a diaphragm with use of a material mixed with carbon fiber and fixing the diaphragm and a frame via an edge.

### CITATION LIST

### Patent Literature

[PTL 1] JP 10-51892 A

### SUMMARY OF INVENTION

### Technical Problems

In the headphone driver in which the diaphragm and the frame are fixed to each other via the edge as disclosed in Patent Literature 1, the diaphragm in which carbon fiber is mixed into paper needs to be manufactured in a manner that carbon fiber is accurately weighed and mixed with paper in the manufacturing process. When the mixed content of carbon fiber deviates from a proper value, the characteristics of the diaphragm are adversely affected, which leads to deterioration in sound quality. Thus, precise control is necessary for the mixed use of carbon fiber to be mixed into paper. In particular, in order to improve the frequency characteristics of the diaphragm, it is necessary to manufacture the diaphragm so that the characteristics of the material of the edge and the characteristics in the state in which the edge and the diaphragm are combined may be optimum, and hence the weighing of carbon fiber is important.

Further, also in the step of mixing paper and carbon fiber, great care needs to be taken to mix paper and carbon fiber uniformly. Accordingly, a high manufacturing technology is required in the diaphragm manufacturing process.

Still further, in the manufacturing process requiring a high manufacturing technology, an apparatus to be used and the like needs to be high in accuracy, and its maintenance cost is high. Besides, carbon fiber is expensive, which leads to an increase in cost of the diaphragm itself.

It is an object of the present invention to provide a headphone device and a headphone driver configured to output an audio signal, each of which includes a diaphragm that can be manufactured at low cost without the need of any high manufacturing process technology in the manufacturing of the diaphragm and that is capable of suppressing a resonance frequency at high frequency and thus reproducing an audio signal without sound quality deterioration in a wide bandwidth.

### Solution to Problems

In order to solve the above-mentioned problems, a headphone device according to one embodiment of the present invention includes: two headphone driver units each configured to output an acoustic signal based on an audio signal; an ear pad mounted to each of the two headphone driver units; and a headphone band for connecting the two headphone driver units, in which the two headphone driver units each include a headphone driver including: a diaphragm; a voice coil fixed to the diaphragm; a magnet mounted in adjacent to the voice coil; a yoke mounted on an opposite side of the magnet across the voice coil; and a frame on which the magnet and the yoke are mounted and to which an outer peripheral portion of the diaphragm is fixed, and in which the diaphragm is molded by mixing a nanofiber material into a paper material.

Further, a headphone device according to one embodiment of the present invention includes: two headphone driver units each configured to output an acoustic signal based on an audio signal; an ear pad mounted to each of the two headphone driver units; and a headphone band for connecting the two headphone driver units, in which the two headphone driver units each include a headphone driver including: a diaphragm; a voice coil fixed to the diaphragm; a magnet mounted in adjacent to the voice coil; a yoke mounted on an opposite side of the magnet across the voice coil; a frame on which the magnet and the yoke are mounted; and an edge for fixing the diaphragm to the frame, and in which the diaphragm is molded by mixing a nanofiber material into a paper material.

Further, in the headphone device according to one embodiment of the present invention, the edge is made of a material different from a material of the diaphragm, and is formed of an elastomer material.

Further, in the headphone device according to one embodiment of the present invention, the diaphragm is molded by mixing the nanofiber material into the paper material at a ratio of from 20% to 30%.

A headphone driver according to one embodiment of the present invention includes: a diaphragm; a voice coil fixed to the diaphragm; a magnet mounted in adjacent to the voice coil; a yoke mounted on an opposite side of the magnet across the voice coil; and a frame on which the magnet and the yoke are mounted and to which an outer peripheral portion of the diaphragm is fixed, in which the diaphragm is molded by mixing a nanofiber material into a paper material.

Further, a headphone driver according to one embodiment of the present invention includes: a diaphragm; a voice coil fixed to the diaphragm; a magnet mounted in adjacent to the voice coil; a yoke mounted on an opposite side of the magnet across the voice coil; a frame on which the magnet and the yoke are mounted; and an edge for fixing the diaphragm to the frame, in which the diaphragm is molded by mixing a nanofiber material into a paper material.

Further, in the headphone driver according to one embodiment of the present invention, the edge is made of a material different from a material of the diaphragm, and is formed of an elastomer material.

Further, in the headphone driver according to one embodiment of the present invention, the diaphragm is molded by mixing the nanofiber material into the paper material at a ratio of from 20% to 30%.

### Advantageous Effects of Invention

As described above, according to one embodiment of the present invention, the headphone device and the headphone driver capable of reproducing an audio signal without sound quality deterioration in a wide bandwidth by suppressing a resonance frequency at high frequency can be provided, each of which includes the diaphragm that can be manufactured at low cost without the need of any high manufacturing process technology in the manufacturing of the diaphragm.

### BRIEF DESCRIPTION OF DRAWINGS

FIG. 1 are views illustrating schematic configurations of a headphone device and a headphone driver according to an embodiment of the present invention.

FIG. 2 are images showing materials of a diaphragm of the headphone driver according to the embodiment of the present invention.

FIG. 3 are graphs showing distortion characteristics of the diaphragm of the headphone driver according to the embodiment of the present invention.

FIG. 4 are graphs showing frequency characteristics of the headphone driver according to the embodiment of the present invention.

FIG. 5 are views each showing a vibrating state of a diaphragm made of a polyester material in a related-art headphone driver.

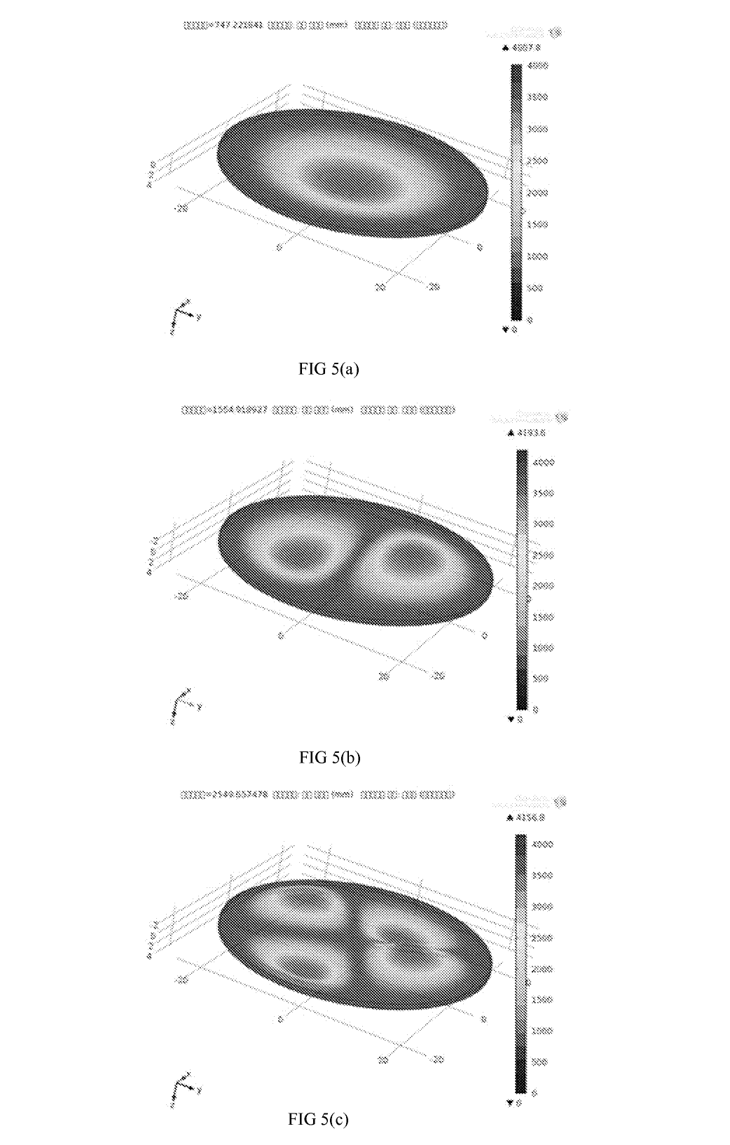

FIG. 6 is a graph showing frequency characteristics of the related-art headphone driver.

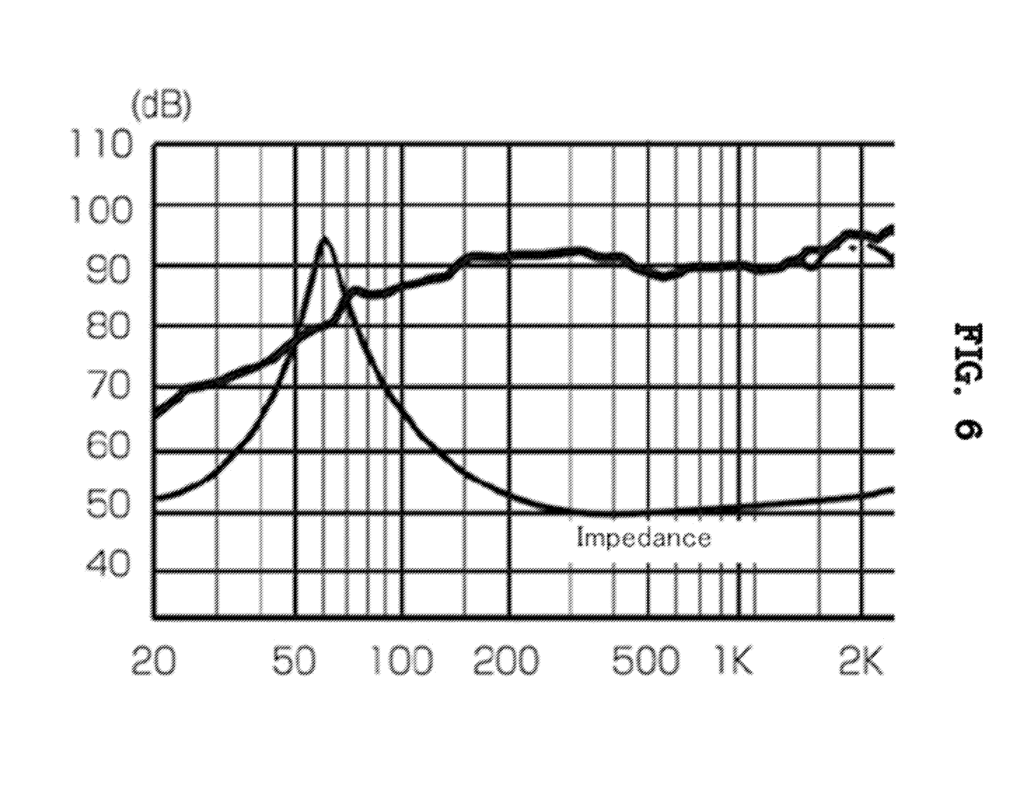

### DESCRIPTION OF EMBODIMENT

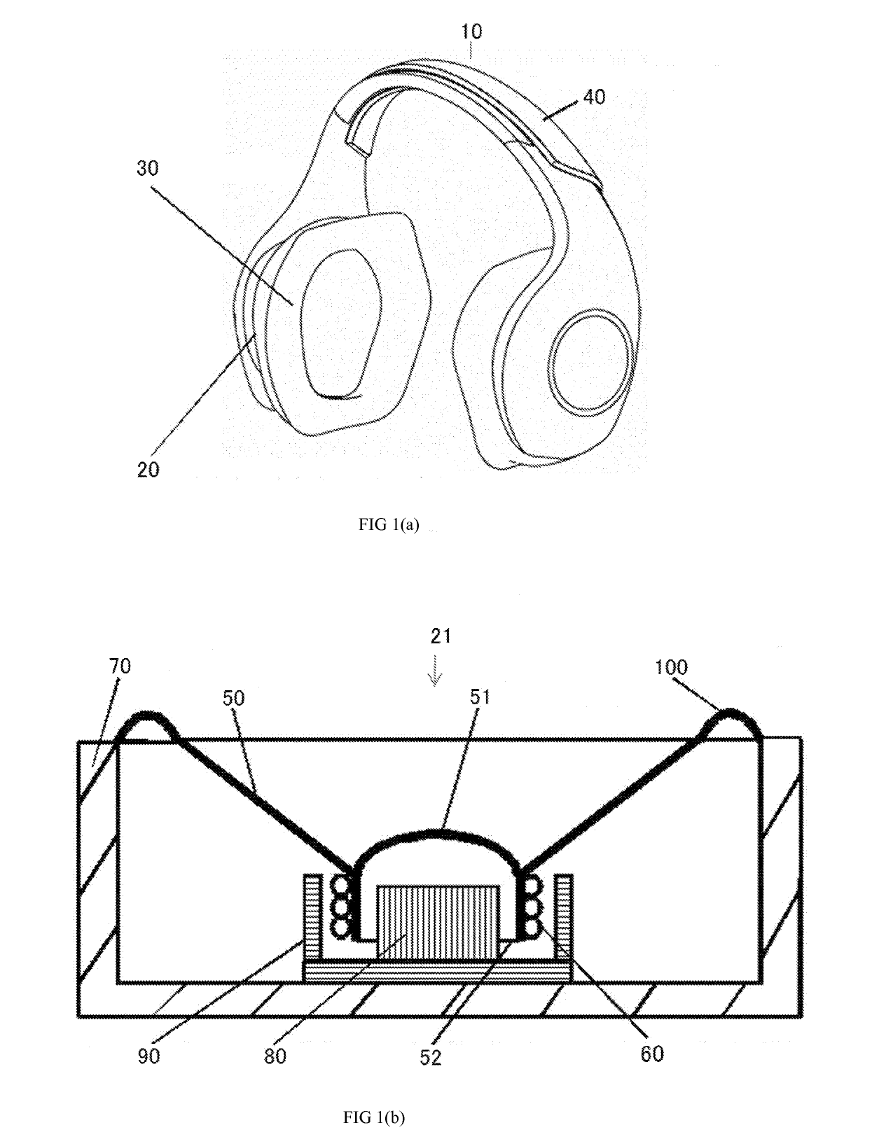

FIG. 1 are views illustrating schematic configurations of a headphone device and a headphone driver according to an embodiment of the present invention. FIG. 1(a) is a schematic view of the headphone device according to this embodiment, and FIG. 1(b) is a schematic sectional view of the headphone driver according to this embodiment.

A headphone device 10 illustrated in FIG. 1(a) includes two headphone driver units 20, ear pads 30 mounted to the respective headphone driver units 20, and a headphone band 40 for connecting the two headphone driver units. The headphone device 10 is designed to be worn over the head so that the headphone band 40 abuts the head and the two ear pads 30 abut the ears.

The headphone driver units 20 each include a headphone driver 21 inside. As illustrated in FIG. 1(b), the headphone driver 21 includes a diaphragm 50, a voice coil 60, a frame 70, a magnet 80, a yoke 90, and an edge 100.

The diaphragm 50 has a substantially conical shape, and includes a diaphragm center portion 51 at a center portion thereof. The diaphragm 50 further includes a diaphragm cylindrical portion 52 on the opposite side of the diaphragm center portion 51, for mounting the voice coil 60 to be described later thereon. As described later, the diaphragm 50 is made mainly of a paper material, and is manufactured by mixing nanofiber into paper and through integral molding. The voice coil 60 is fixed to the diaphragm cylindrical portion 52.

The magnet 80 is mounted on the frame 70 on an inner side of the diaphragm cylindrical portion 52 and the yoke 90 is mounted on the frame 70 on an outer side of the diaphragm cylindrical portion 52 so that the magnet 80 and the yoke 90 may sandwich the voice coil 60 mounted on the diaphragm cylindrical portion 52. Note that, the arrangement of the magnet 80 and the yoke 90 with respect to the diaphragm cylindrical portion 52 may be reversed.

The diaphragm 50 and the frame 70 are connected to each other via the edge 100 formed of an elastomer material, such as polyurethane and silicon rubber. The edge 100 has a ring shape, and has an inverse U-shaped cross section. One end of the edge 100 is connected to the diaphragm 50, and the other end thereof is connected to the frame 70.

Note that, the cross section of the edge 100 may have another shape such as a U-shape or a wave shape. When the edge 100 is formed to have a U-shaped cross section, no protrusion toward the upper side of the diaphragm 50 is formed in the headphone driver 21, and hence the headphone driver 21 can be thinned.

Alternatively, when the edge 100 is formed to have a wave-shaped cross section, a margin of rigidity of the diaphragm 50 to vibration is increased due to the waved portion, and hence the diaphragm 50 vibrates more softly. In other words, frequency characteristics in the low-pitched range are further improved.

The magnet 80 and the yoke 90, which are fixed to the frame 70, form a magnetic circuit. When an electrical signal based on an audio signal flows through the voice coil 60 arranged between the magnet 80 and the yoke 90, the diaphragm 50 having the voice coil 60 mounted thereon vibrates. Sound waves are generated by the vibration, and an audio signal is output.

The diaphragm 50 of the present invention is now described.

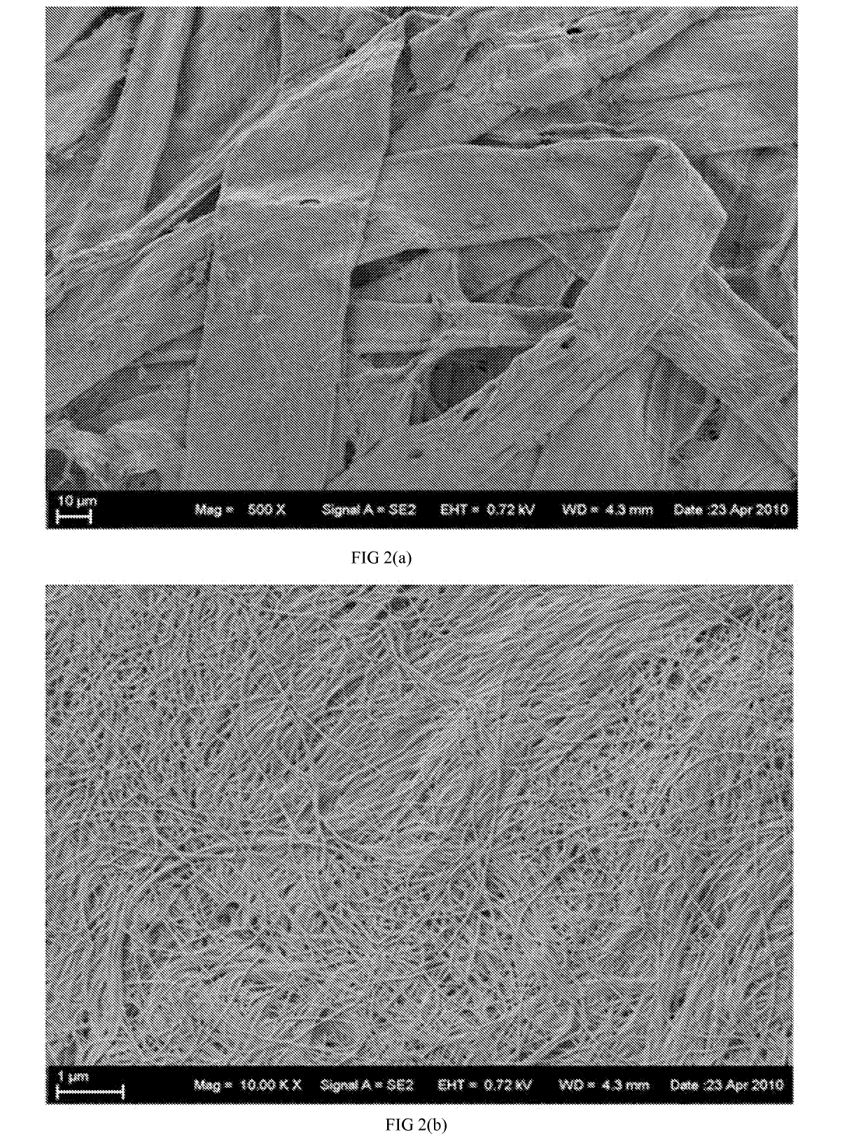

FIG. 2 are images showing the materials for the diaphragm of the headphone driver according to this embodiment. FIG. 2(a) is an enlarged image of the paper material, and FIG. 2(b) is an enlarged image of the nanofiber material.

The diaphragm 50 of the present invention is made basically of the paper material shown in FIG. 2(a), and contains the nanofiber shown in FIG. 2(b) that is mixed into the paper material. The diaphragm 50 is manufactured by integral molding. In FIG. 2(a), the paper material is a fiber material having a width of 10 μm to 50 μm. In FIG. 2(b), the nanofiber is a fiber material having a width of 30 nm to 90 nm. Those materials are mixed to manufacture an integrally formed diaphragm 50.

The diaphragms 50 were produced with different mixture ratios of the nanofiber material to the paper material, including a diaphragmmade only of the paper material (nanofiber 0%), diaphragms with sequentially increasing mixture ratios of the nanofiber material, and a diaphragm made only of the nanofiber material (nanofiber 100%). An audio signal was reproduced by each of the diaphragms 50, and the deterioration in sound quality was investigated. The diaphragm 50 in which the nanofiber material was mixed into the paper material at the ratio of from 20% to 30% was less in sound quality deterioration at audible high frequencies as compared to the diaphragms 50 having other mixture ratios, and was able to reproduce an audio signal having good sound quality from low frequencies to high frequencies.

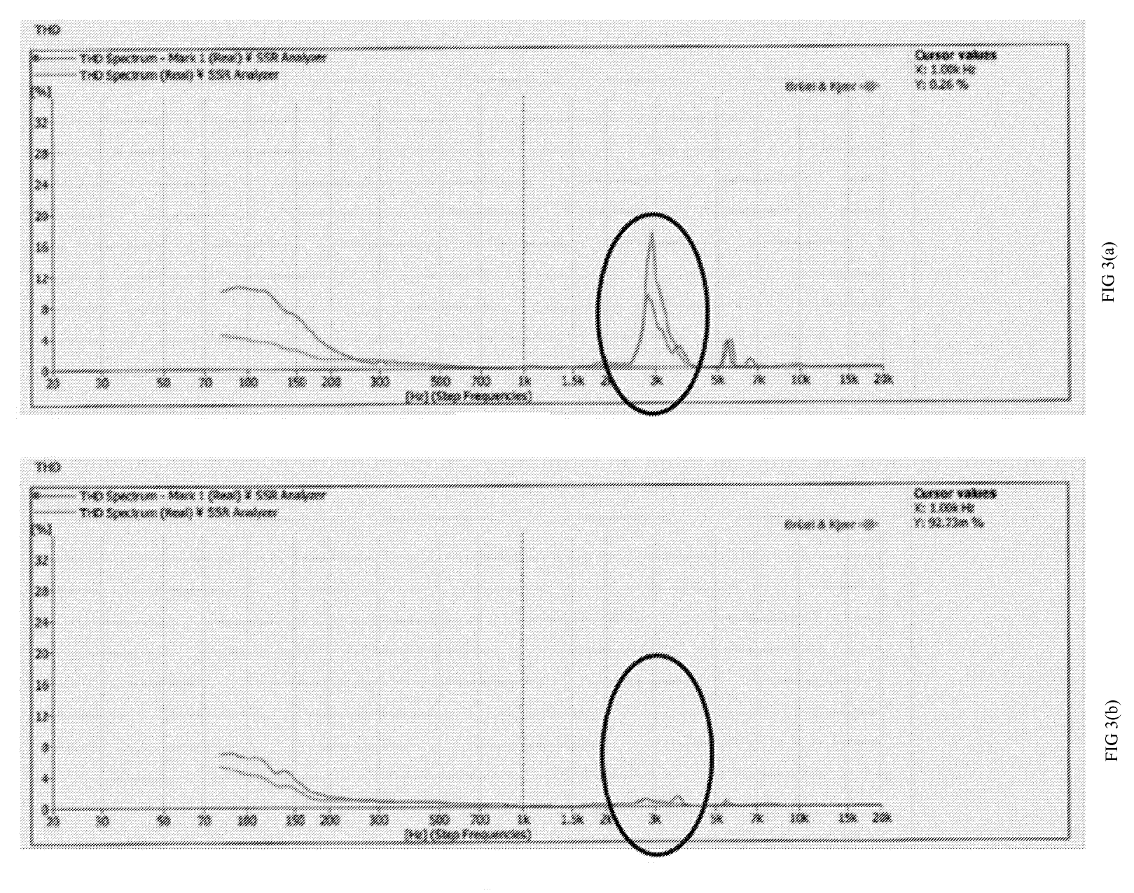

FIG. 3 are graphs showing distortion characteristics of the diaphragm of the headphone driver according to this embodiment. FIG. 3(a) is a graph showing distortion characteristics of a related-art diaphragm made of a polyester material. FIG. 3(b) is a graph showing distortion characteristics of the diaphragm in which the paper material and the nanofiber material are mixed according to this embodiment.

In the case of the diaphragm manufactured only by the polyester material, as shown in FIG. 3(a), the distortion characteristics of the diaphragm are such that a peak occurs in the distortion characteristics around 3 kHz. This peak leads to deterioration of sound quality.

On the other hand, in the case of the diaphragm 50 according to this embodiment in which the nanofiber material is mixed into the paper material, as shown in FIG. 3(b), the distortion characteristics of the diaphragm 50 are such that no peak occurs around 3 kHz, and the characteristics are flat with no deterioration in sound quality. Thus, an audio signal can be reproduced without sound quality deterioration from low frequencies to high frequencies. In particular, in the diaphragm 50 in which the nanofiber material is mixed at the ratio of from20% to 30%, the sound quality of audibility was better. In view of those results, an appropriate mixture ratio of the paper material and the nanofiber material is 20% to 30% of the nanofiber material.

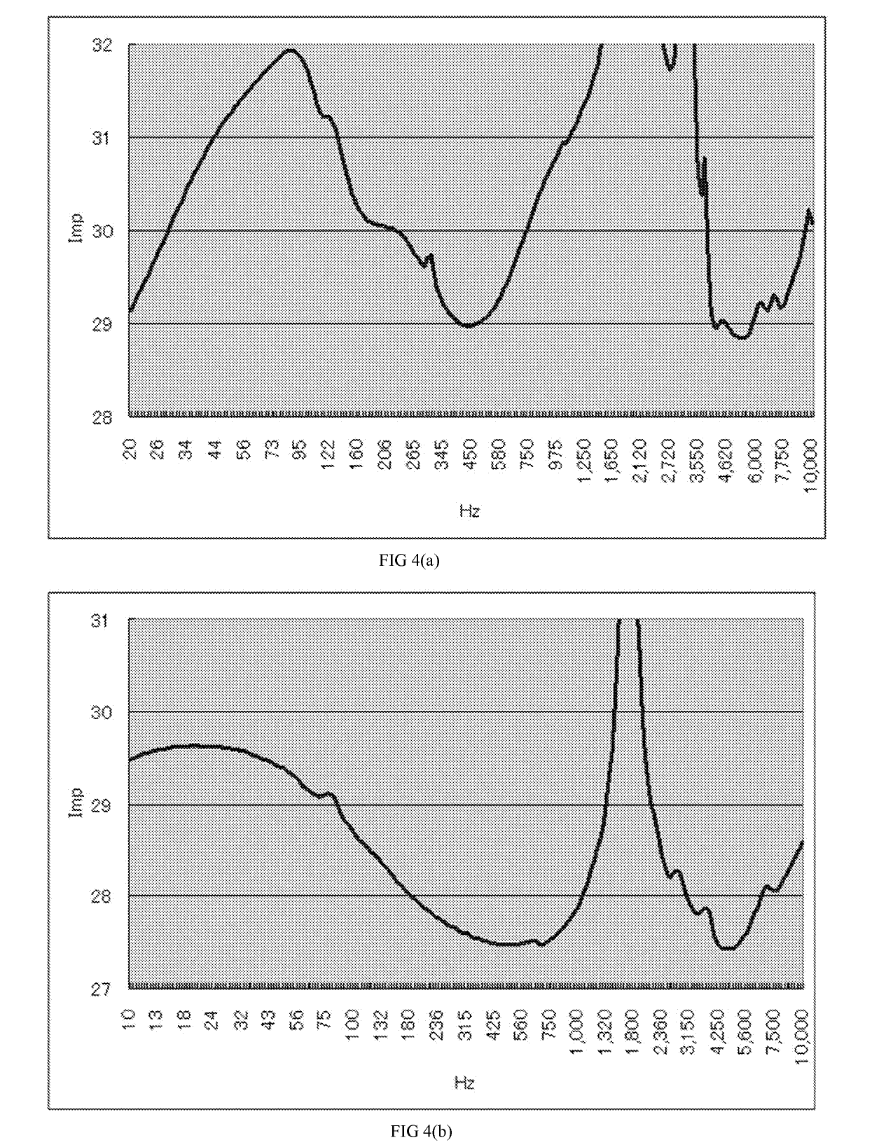

FIG. 4 are graphs showing frequency characteristics of the headphone driver according to this embodiment. FIG. 4(a) is a graph showing frequency characteristics of a related-art headphone driver in which no edge is provided between the diaphragm and the frame. FIG. 4(b) is a graph showing frequency characteristics of the headphone driver in which the edge is provided according to this embodiment.

The diaphragm 50 and the frame 70 are connected to each other via the edge 100 formed of an elastomer material, and hence the minimum resonance frequency of the entire diaphragm 50 including the edge 100 is decreased. FIG. 4(a) shows frequency characteristics when the diaphragm using no edge is connected directly to the frame. In the frequency characteristics, the minimum resonance frequency is located in the vicinity of approximately 95 Hz. FIG. 4(b) shows frequency characteristics when the diaphragm 50 and the frame 70 are connected to each other via the edge 100 formed of an elastomer material. In the frequency characteristics, the minimum resonance frequency is located in the vicinity of approximately 18 Hz.

In this manner, the diaphragm 50 and the frame 70 are connected to each other via the edge 100 formed of an elastomer material, and hence the minimum resonance frequency of the headphone driver 21 moves to a low frequency, and the decrease in signal level at low frequency can be suppressed. Consequently, reproducibility of an audio signal in the low-pitched range is improved, and the audio signal can be reproduced without sound quality deterioration in a wide bandwidth.

As described above, according to the present invention, the diaphragm 50 of the headphone driver 21 to be used for the headphone device 10 is made mainly of the paper material, and the nanofiber material is mixed into the paper material, and hence a resonance frequency at high frequency of the diaphragm 50 can be suppressed. Consequently, the deterioration caused by a resonance frequency at high frequency can be reduced.

Further, the nanofiber material to be mixed into the paper material is easily available unlike other materials such as carbon, and is low in cost as compared to special materials such as carbon.

In addition, also in the manufacturing process for the diaphragm 50, no carbon material is used, and hence the diaphragm 50 can be manufactured without any additional complicated steps such as the step of finely managing the mixture ratio of the carbon material and the step of sufficiently mixing two materials. In other words, in the process of manufacturing the diaphragm 50, by mixing the paper material and the nanofiber material together, two materials can be mixed together with ease. By subjecting the mixed materials to paper-making, the materials to be the base of the diaphragm 50 can be produced. When the obtained materials are used and integrally molded into the shape of the diaphragm 50, the diaphragm 50 can be manufactured. In this manner, the diaphragm 50 can be manufactured through a general pulp manufacturing process without adding any complicated step. No need to add any manufacturing step can maintain the low manufacturing cost.

Therefore, the present invention can provide the headphone device and the headphone driver capable of reproducing an audio signal without sound quality deterioration in a wide bandwidth by suppressing a resonance frequency at high frequency, each of which includes the diaphragm that can be manufactured at low cost without the need of any high manufacturing technology in the manufacturing of the diaphragm.

The headphone driver 21 according to this embodiment includes the diaphragm 50, which is formed by mixing the nanofiber material into the paper material, and the edge 100. In order to further downsize the headphone driver 21, however, the headphone driver 21 may include only the diaphragm 50 formed by mixing the nanofiber material into the paper material, without including the edge.

### INDUSTRIAL APPLICABILITY

The present invention can be usefully used for a headphone device.

### REFERENCE SIGNS LIST

10 . . . headphone device

20 . . . headphone driver unit

21 . . . headphone driver

30 . . . ear pad

40 . . . headphone band

50 . . . diaphragm, 51 . . . diaphragm center portion, 52 . . . diaphragm cylindrical portion

60 . . . voice coil

70 . . . frame

80 . . . magnet

90 . . . yoke

100 . . . edge)

1. A headphone device, comprising:
two headphone driver units each configured to output an acoustic signal based on an audio signal;
an ear pad mounted to each of the two headphone driver units; and
a headphone band for connecting the two headphone driver units,
the two headphone driver units each comprising a headphone driver comprising:
a diaphragm;
a voice coil fixed to the diaphragm;
a magnet mounted in adjacent to the voice coil;
a yoke mounted on an opposite side of the magnet across the voice coil; and
a frame on which the magnet and the yoke are mounted and to which an outer peripheral portion of the diaphragm is fixed,
the diaphragm being molded by mixing a nanofiber material into a paper material.

2. A headphone device, comprising:
two headphone driver units each configured to output an acoustic signal based on an audio signal;
an ear pad mounted to each of the two headphone driver units; and
a headphone hand for connecting the two headphone driver units,
the two headphone driver units each comprising a headphone driver comprising:
a diaphragm;
a voice coil fixed to the diaphragm;
a magnet mounted in adjacent to the voice coil;
a yoke mounted on an opposite side of the magnet across the voice coil;
a frame on which the magnet and the yoke are mounted; and
an edge for fixing the diaphragm to the frame,
the diaphragm being molded by mixing a nanofiber material into a paper material.

3. A headphone device according to claim 2, wherein the edge is made of a material different from a material of the diaphragm, and is formed of an elastomer material.

4. A headphone device according to claim 1, wherein the diaphragm is molded by mixing the nanofiber material into the paper material at a ratio of from 20% to 30%.

5. (canceled)

6. A headphone driver, comprising;
a diaphragm;
a voice coil fixed to the diaphragm;
a magnet mounted in adjacent to the voice coil;
a yoke mounted on an opposite side of the magnet across the voice coil;
a frame on Which the magnet and the yoke are mounted; and
an edge for fixing the diaphragm to the frame,
the diaphragm being molded by mixing a nanofiber material into a paper material,

7. A headphone driver according to claim 6, wherein the edge is made of a material different from a material of the diaphragm, and is formed of an elastomer material.

8. A headphone driver according to claim 6, wherein the diaphragm is molded by mixing the nanofiber material into the paper material at a ratio of from 20% to 30%.
